(19) United States
(12) Patent Application Publication
(10) Pub. No.: US 2017/0284690 A1
(43) Pub. Date: Oct. 5, 2017

(54) MOBILE ENVIRONMENT MONITORING SYSTEM

(71) Applicant: Softarex Technologies, Inc., Alexandria, VA (US)

(72) Inventor: Oleksandr LIPANOV, Kharkiv (UA)

(73) Assignee: Softarex Technologies, Inc., Alexandria, VA (US)

(21) Appl. No.: 15/088,658

(22) Filed: Apr. 1, 2016

(51) Int. Cl. F24F 11/00; G05B 15/02; H04Q 9/00

(52) U.S. Cl. CPC F24F 11/006; H04Q 9/00; G05B 15/02; H04Q 2209/40

(57) ABSTRACT

An environmental monitoring system having a monitoring device, a cloud-based server, mobile devices, remote sensors and hardwired sensors, such that each of the system devices is configured to communicate with the rest of the system and the mobile devices provide user access and control. This system provides a comprehensive hardware and software solution designed for complex environment monitoring applications. It collects and analyzes various environmental parameters, allowing for the results to be displayed on a smartphone and for the data to be transferred to a server for further processing and monitoring.

### FIELD OF THE INVENTION

The invention is related to a comprehensive hardware and software solution for remote environment monitoring of buildings, residences and commercial sites.

### DESCRIPTION OF THE PRIOR ART

Building intelligence systems began as emergency alert systems with basic smoke detection and power control. These systems were connected to hardline phone systems and usually did not allow for outside access. The one-way access was directed to emergency services or utility companies for dispatch of emergency response teams and maintenance personnel. Then as heating ventilation and air conditioning (HVAC) systems became more widespread, the building climate required constant monitoring and control.

HVAC control systems were primarily hardware which required physical access to control and update. Many legacy systems for commercial building were simply timer-based on/off switches with a simple thermostat to maintain a certain range of temperatures. Thus, the feedback to the user or building administrator remained limited even as more systems were being controlled.

While emergency fire and HVAC monitoring are important, modern building design requires far more comprehensive monitoring. Particularly, regulatory agencies require monitoring of a number of toxins and gases in work places including offices and warehouses. In addition, the levels of dust and particulates are now considered workplace and residential hazards in some countries. Therefore, for building managers and workers a number of variables now must be tracked periodically, or continuously.

In addition, property managers are increasingly located remotely, requiring accessible systems that can be controlled, read and updated without physical access. Likewise, building engineers require targeted maintenance and feedback on system failures so that the appropriate maintenance teams can be dispatched. These demands would require interfacing with a number of distributed hardware systems as well as storage and analysis of data derived from these systems.

One such system, an environmental monitoring device, is disclosed in Gettings et al. (US Pub. No. 2015/0020614 A1). The device includes a sensor mechanism and a processor, within the cavity, that provides sensor data based on measurements of an environmental condition in an external environment that includes the environmental monitoring device. The fluid flow is associated with operation of the processor, and the processor is positioned relative to the sensor mechanism so that the fluid flow is directed over the sensor mechanism to facilitate the measurements.

Moreover, the sensor mechanism may include: an air-quality sensor, a particle counter, and/or a volatile-organic-compound sensor. In addition, the sensor data and/or the analyzed sensor data may be communicated or shared with one or more other electronic devices, such as data-sharing electronic device (e.g., a cellular telephone or a portable electronic device) and/or remote servers or computers.

However, this system is a standalone device that does all the analysis locally. Furthermore, the sensors for the device are predetermined and cannot be easily upgraded or changed. Thus, the number and variety of sensors which can be selected or used by a customer is limited and would require additional or separate manufacturing of this system.

In addition, the sensing capabilities are limited to airborne environmental conditions since the sensors are sheltered inside the cavity and only access the outside environment through the air pumped into the device.

### SUMMARY OF THE INVENTION

The invention is directed to an environment monitoring system comprising a monitoring device, a cloud-based server, mobile devices, remote sensors and hardwired sensors. Each of the system devices is configured to communicate with the rest of the system and the mobile devices allow for user access and control of the system. Also each monitoring device includes visual indicators, an authentication tag and can transmit alerts to nearby devices.

The disclosed device is a comprehensive hardware and software solution designed for complex environment monitoring applications. It provides capabilities for collection and analysis of various environmental parameters, allowing for the results to be displayed on a smartphone and for the data to be transferred to a server for further processing and monitoring.

This product can be provided as a single block including some basic sensors or as a modular system with multiple sensors for collecting and analyzing a wide range of different environmental factors. As a modular system, the user can easily set the required sensor configuration, as well as upgrade or replace the actual sensor modules. The software part of the system consists of a cloud solution and a mobile application that allows flexible access to information and provides opportunities for further server-side data analysis with results being displayed in the mobile application.

A data analysis component allows the user to be notified about the presence of harmful environmental factors and also predict their possible emergence due to changes in certain target parameters. If sensors are installed outdoors or in different rooms of a building, there is an option to mark them on a map where results for each sensor will be displayed accordingly.

The wide range of supported sensors allows environment monitoring according to different parameters, including air quality, electromagnetic field intensity, light, noise, pressure, humidity, temperature, etc. As a result, the system can also detect the presence of certain substances that may cause allergy and timely alert the user via the mobile application. Also as a result of the modular structure of the system, it can be expanded to include new allergen sensors as well as sensors for analyzing soil and water quality.

Unlike other known environmental monitoring systems, the disclosed device provides extensible integrated environmental monitoring of over fifteen parameters simultaneously. Moreover, the number of these parameters can be increased with new sensors, which are easily added to the system via standard mini-USB connectors or via industrial wireless data transferring protocols. The system provides a standardized approach for connection to new sensors, thus allowing other manufacturers to participate in the development of new sensors.

Structurally, the system can be configured as an all-in-one box for indoor/outdoor installation. At the same time, the web server application will conduct the analysis of data in different regions and cities and inform users of potential environmental problems. Thus, it will be solving the problem of environmental monitoring not just in one particular building or house, but also on a scale of a region or a whole country. As the use of the system becomes more widespread, it will make the process of environmental conditions monitoring much easier and more efficient.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitative of the present invention, and wherein:

FIG. 1 is a diagram of the environment monitoring system;

FIG. 2 is a schematic of the monitoring device of the system; and

FIG. 3 is an illustration of the detection module according to an embodiment of the invention.

### DETAILED DESCRIPTION OF THE DRAWINGS

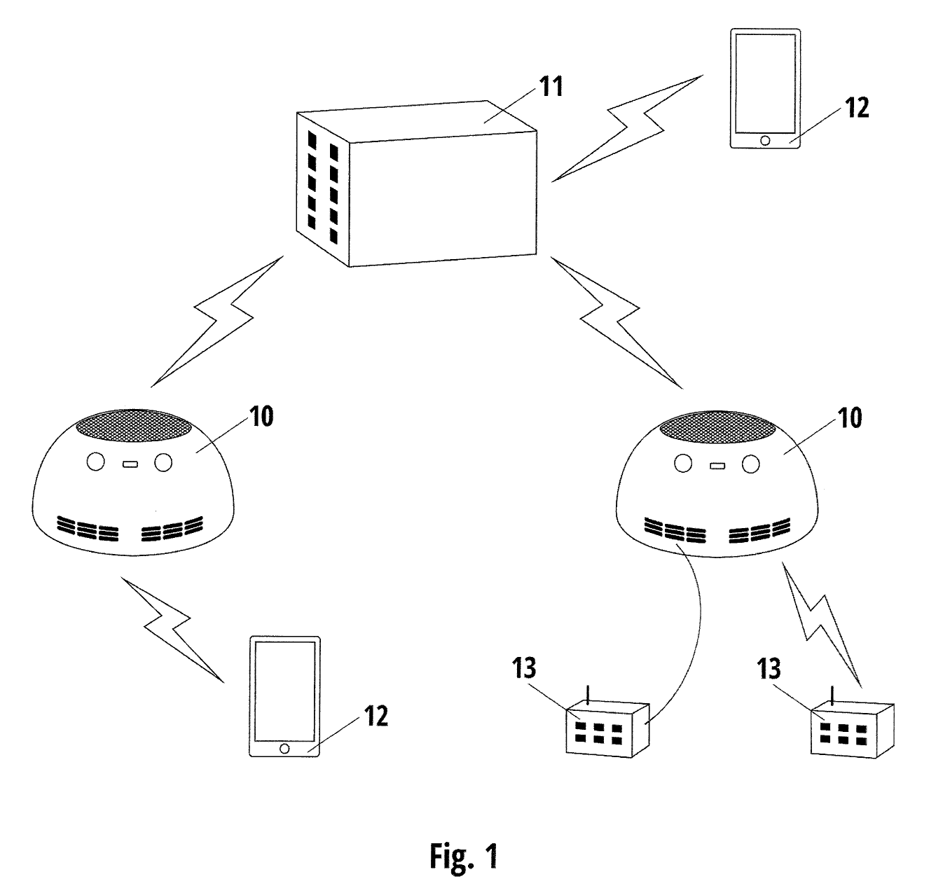

The overall system diagram is shown in FIG. 1 with a number of monitoring devices (10) communicating with a cloud-based server (11). The monitoring devices (10) also communicate directly with mobile devices (12) having a mobile application for interfacing with the monitoring devices (10) or the cloud-based server (11). Each of the monitoring devices includes an array of sensors (13) which test and measure local environmental parameters. The monitoring device (10) also includes at least two cavities or through-holes that allow air to circulate within the device and a fan (23) for increasing airflow into the device.

The air sensors (13) adapted to be connected to the monitoring devices (10) include sensors of CO₂ levels (carbon dioxide), CO levels (carbon monoxide), dust levels, Ethyl alcohol content levels (C₂H₅OH), Combustible gases levels (LPG), Ammonia levels (NH₃), formaldehyde, benzene, and Hydrogen levels (H₂). In addition, the monitoring devices can include sensors (13) for basic habitability or comfort conditions such as noise levels (microphone), light levels, humidity, air temperature, and atmospheric pressure values.

Each monitoring device (10) is advantageously provided with several three-axis semiconductor sensors detecting magnetic fields and radiation levels in three dimensions. For outdoor applications, a monitoring device (10) can be connected to probe sensors in water sources or water drains to assess pollution levels or microbe contamination levels. Other applications may provide for soil condition monitoring, such as soil moisture, temperature and acidity. Yet another application may include sensor for detecting gravity measurements.

Each monitoring device (10) includes a communication module (21) having a transceiver which can communicate via WiFi, Bluetooth, 3G/4G/LTE cellular bandwidths, Dali and EnOcean, ZigBee, LoRa connections to sensors and to the cloud-based server (11). The sensors (13) may be wirelessly connected sensors such as those connectable in an Internet-of-Things or wired sensors connected through micro-USB, Firewire, or the like. The cloud-based server (11) advantageously being connected for a continuous data connection, for example, over Ethernet.

The monitoring devices (10) can be of two form factors, one for indoor applications and one for outdoor applications. The housing for either the indoor application or the outdoor application provides a frame for connecting additional sensors to the outside and nearby USB connection ports for easy connection of the sensor module. The outside housing of the monitoring device (10) advantageously includes colored lighting indicators (22) to alert tenants, workers or building managers of environmental parameters that are unacceptable or out of predetermined ranges.

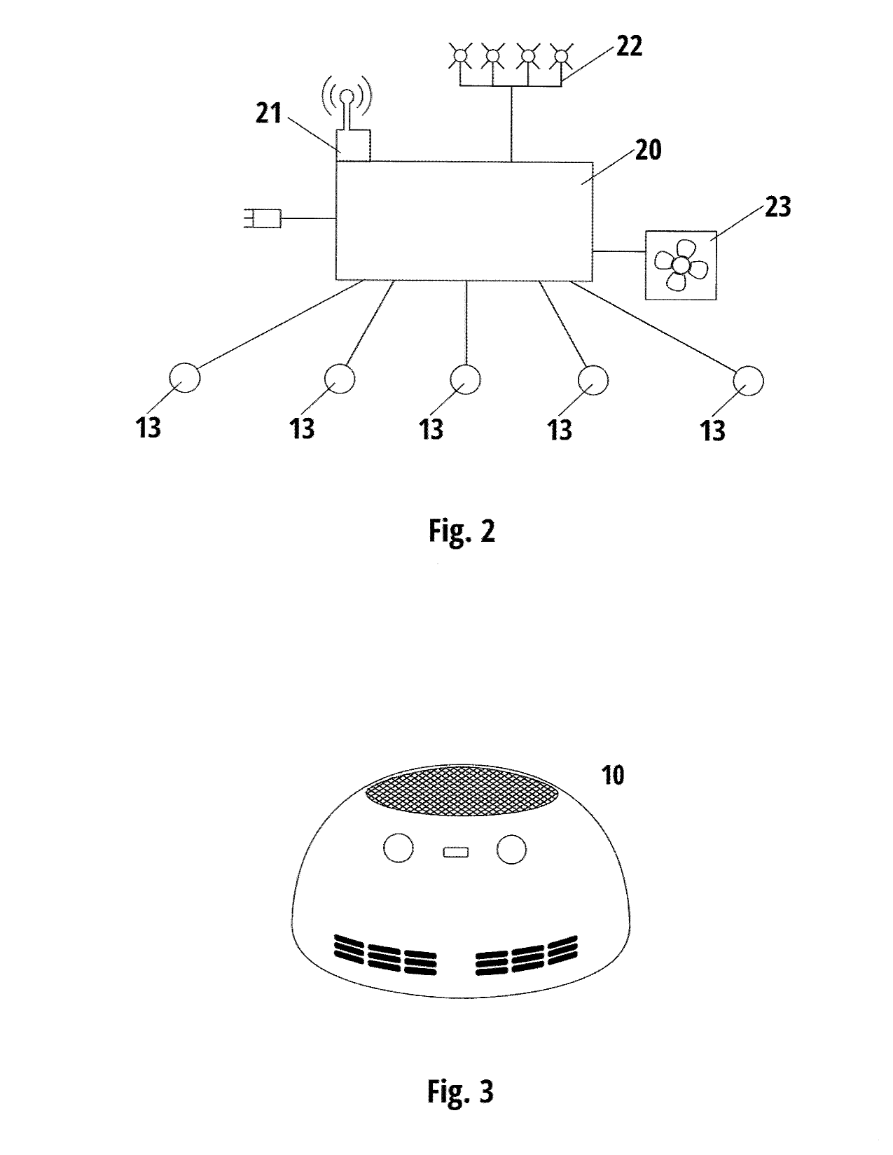

The core of the monitoring device includes a central data processing module (20) as shown in FIG. 2 that includes a CPU, RAM, GPS, a communication bus for connection to the communication module and several USB inputs. The central data processing module can run an embedding LINUX or ANDROID operating system. The monitoring device (10) is configured to auto-detect and auto-configure wireless sensors that are in close proximity or which have been paired with the monitoring device (10). Additionally, all sensors hardwired to the monitoring device (10) are also configured for input.

The monitoring device (10) is designed as a hemisphere as in FIG. 3 with a fan (23) in the center in order to improve air intake such that a wider environmental area can be monitored. The fan (23) turns on automatically based on predetermined values in the program. This allows the device to achieve energy savings while in use. The monitoring device also can be battery powered or connected to the building power supply as in FIG. 2. Alternatively, the device may be recharged wirelessly through a specially-adapted wireless charger.

If the sensors are provided by a third-party or require a third-party API, then the monitoring device can either download the required software from the cloud-based server (11) or downloaded from the newly connected module itself. The cloud-based server (11) can also push out updates to the monitoring devices (10) to add new capabilities, new processing or utilize latent capabilities in already connected sensors. For example, the noise level sensors can be specially adapted to detect specific sounds such as gunfire, machine malfunctions or high pressure gas leaks.

Each monitoring device (10) uploads sensor data to the cloud-based server (11) for collection, analysis and pattern detection. This enables the system to identify anomalies and malfunctioning systems. The monitoring device (10) itself may also connect to emergency services directly to notify them when smoke, carbon monoxide or excessive heat are detected. Other emergency conditions can also be set for alerts to building personnel and particularly sensitive building users.

Certain gases or particles detected by the system can be allergens to some people. If detected, the analysis system of the cloud-based server (11) will notify an inhabitant of the environment (via the mobile application) that there are certain types of allergens present in the environment. User notification of the presence of potentially harmful allergens in the air can be determined according to geolocation or localized pairing. This opens the potential user base of the mobile application to include anyone regularly using the building.

Authorization to receive alerts from particular environments may be established through the mobile application. The alerts can then be received directly from the monitoring device (10) or the cloud-based server (11). If the mobile application user is remote from the environment, the alerts may still be received or can be selectively turned off. Alternatively, only local mobile devices are alerted, and particularly only authorized local mobile devices. The mobile device may be a cellular phone, a tablet, a smart watch, a laptop, or an engineering control panel. Other devices can also be connected, so that the data and alerts can be sent to any other electronic device.

The mobile application can be run on iOS, ANDROID, WINDOWS Embedded, and other mobile operating systems. The mobile application receives regular updates of environmental measurements, and can allow management of measurement history through communication with the server (11). The application can also allow authorized users to directly manage and configure the central data processing module (20) and the sensors (13) of the monitoring device (10). Finally, the application displays analytical information and recommendations for environmental condition improvements.

Initialization of communication with the monitoring device begins by imaging a special QR code found on the actual device. The QR code contains a unique number of the device's Bluetooth adapter (or other unique number). This number is used to ensure that the device is only paired with this specific monitoring device. Also at this stage, the user profile for the mobile application can be created on a system website that interfaces with the cloud-based server (11). Furthermore, authorized devices with full control credentials may also interface with building control systems to actively adjust environment variables. This connection to building control systems can either be through the cloud-based server (11) or the relayed through the monitoring device (10).

The user account includes device registration, purchase history, personal health profile, measurement history, an analytical information expert system, and account settings. For additional data access, a full access API key can provide statistical information on all measured parameters, with the possibility of mapping this sensor data with the demographics of users. The data will be supplied without the users' personal information to those organizations that need to know the status of the users' environmental conditions. For example, regulatory agencies could be given access to this resource.

An example of monitoring device (10) can be seen in FIG. 3. This monitoring device can be used in trucks, trains, cargo containers, shipping vessels, houses, barns, warehouses, manufacturing facilities, commercial properties, farms, offices, smart city systems and space vehicles. In each case, a core number of sensors are provided and the additional desired sensors are added by the user for each specific use case.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An environment monitoring device, comprising:
a processor receiving data from at least two sensors;
a transceiver connected to the processor and communicating with the sensors and at least two mobile devices;
a fan that draws air from the environment through at least two cavities in an outside housing of the monitoring device and over the sensors; and
a cloud-based server connected to the monitoring device and receiving measurement data from the monitoring device,
wherein the monitoring device is configured to receive automatic software updates from the cloud-based server, and wherein the measurement data on the cloud-based server is accessible via the at least two mobile devices.

2. The monitoring device of claim 1, wherein the monitoring device provides alerts to emergency personnel, if an emergency is detected, wherein the emergency includes smoke, excess CO₂, excess CO, or excess heat.

3. The monitoring device of claim 1, wherein the monitoring device provides proximity-based information to occupants of an environment being monitored, wherein the proximity-based information are emergency messages, allergen warnings or ambient air statistics.

4. The monitoring device of claim 1, wherein the measurement data is regularly transmitted from the cloud-based server to a government regulatory system for review.

5. The monitoring device of claim 1, wherein upon connection of a new sensor to the monitoring device, the monitoring device downloads necessary software updates from the cloud-based server and automatically configures the new sensor for use.

6. The monitoring device of claim 1, wherein each of the mobile devices is paired with at least one monitoring device, wherein each of the mobile devices is authorized to receive information from the at least one monitoring device, wherein authorization between each mobile device and each of the at least one monitoring device is established by imaging a unique QR code on each of the at least one monitoring devices.

7. The monitoring device of claim 1, the monitoring device further comprising:
lighting indicators connected to the processor and controlled to indicate a safety or acceptability of the environment.

8. The monitoring device of claim 1, wherein the cloud-based server is connected with a control-authorized mobile device, and wherein the control-authorized device can change settings of the monitoring device and analyze the measurement data through the cloud-based server.

9. The monitoring device of claim 1, wherein the monitoring device is connected to building control systems, and wherein the building control systems include a power supply, a heating control system, an air conditioning control system, an alarm system, and a lighting system.

10. The monitoring device of claim 9, wherein the monitoring device controls the building control systems based on measured sensor values.

11. The monitoring device of claim 1, wherein the cloud-based server is connected to building control systems, wherein the building control systems include a power supply, a heating control system, an air conditioning control system, an alarm system, and a lighting system, and wherein the cloud-based server controls the building control systems based on the measurement data from the sensors.

12. The monitoring device of claim 1, wherein the sensors are selected from a group comprising:
carbon dioxide sensors, carbon monoxide sensors, dust sensors, Ethyl alcohol sensors, combustible gas sensors, Ammonia sensors, formaldehyde sensors, benzene sensors, and hydrogen sensors, noise sensors, light sensors, humidity sensors, air temperature sensors, and atmospheric pressure sensors.

12. The monitoring device of claim 1, wherein the sensors are probe sensors inserted into water sources, water drains, or soil to detect pollution, microbes or chemical contamination.

13. An environment monitoring system, comprising:
an environment monitoring device including a processor, a transceiver, a fan, a housing, at least two sensors, and a lighting indicator; the processor receiving data from the at least two sensors; the transceiver connected to the processor and communicating with the sensors; and the fan drawing air from the environment through at least two cavities in the housing of the monitoring device and over the sensors; and
at least two mobile devices connected to the environment monitoring device via the transceiver;
a cloud-based server connected to the monitoring device and receiving measurement data from the monitoring device, the measurement data being generated by the at least two sensors,
wherein the measurement data on the cloud-based server is accessible via the at least two mobile devices, and wherein the cloud-based server is connected to environment control systems to actively adjust the environment variables based on the measurement data.
